(19) United States
(12) Patent Application Publication
(10) Pub. No.: US 2005/0094850 A1
(43) Pub. Date: May 5, 2005

(54) Location information recognition apparatus and method and recording medium

(75) Inventor: Akihiko Nakao, Tokyo (JP)

Correspondence Address: PILLSBURY WINTHROP, LLP, P.O. BOX 10500, MCLEAN, VA, 22102, US

(73) Assignee: Kabushiki Kaisha Toshiba, Tokyo (JP)

(21) Appl. No.: 11/003,426

(22) Filed: Dec. 6, 2004

Related U.S. Application Data
(63) Continuation of application No. 09/708,575, filed on Nov. 9, 2000.

(30) Foreign Application Priority Data
Nov. 9, 1999 (JP) 11-318819

(51) Int. Cl. G06K 9/00; G06K 9/72

(52) U.S. Cl. 382/103; 382/229

(57) ABSTRACT

This invention is to construct and address recognition apparatus using uniform hardware without customizing apparatuses dedicated to different countries even when the address form changes depending on the country. Hence, location information in various countries can be recognized by only a small modification.

### CROSS-REFERENCE TO RELATED APPLICATIONS

This application is based upon and claims the benefit of priority from the prior Japanese Patent Application No. 11-318819, filed Nov. 9, 1999, the entire contents of which are incorporated herein by reference.

### BACKGROUND OF THE INVENTION

The present invention relates to a location information recognition method and apparatus for recognizing an address as location information, and a recording medium.

Generally, to optically read address information (location information) written on a postcard or business card using an optical character reading apparatus (OCR apparatus), the image on the letter is read first, a region having an address is designated or estimated, and lines or characters are extracted from the region.

The OCR apparatus incorporates a place name dictionary for the target recognition area. The address is recognized by reading the characters written in the address region while collating them with the dictionary.

As an address recognition scheme, generally in Japan, the character string of wide area information such as a prefecture name or city name is detected first, and a subsequent character string is read as detail area information such as a town name. After this, for example, a specific character or character string is detected, thereby improving the address recognition rate.

A case wherein a search pattern sequence is a character string obtained by character recognition processing, and a dictionary pattern sequence is a candidate of character string of an address names registered in a word dictionary will be described below in detail.

The versatility of the apparatus will be described first.

For example, in different countries, the address forms are completely different in many cases. For example, in Japan, an address is normally written from a wide area name. In Europe or America, however, a street name is written first, and then, a city name or state name is written. For this reason, not only the place name dictionary used for address recognition but also the address recognition procedure must be changed depending on countries.

The difference in address recognition procedure between countries is a serious problem in developing a versatile address recognition apparatus. For example, even when an address recognition apparatus which has been developed for the English-speaking zone is modified to recognize an address in the French-speaking zone by modifying only the place name dictionary for the French-speaking zone, no satisfactory performance can be obtained. To do this, the address recognition procedure for the French-speaking zone must be introduced. However, adjusting the circuit of the apparatus for each country results in an increase in cost.

Recognition errors for similar place names will be described next.

For example, assume that an area has city names “YORK”, “NORTH YORK”, and “EAST YORK”. In recognizing an address in that area, even when part of the address line is recognized as “YORK”, the actual city name written there may be “NORTH YORK”.

Conversely, even when “EAST YORK” is recognized, this “EAST” may be a recognition error for another word.

Word narrow-down dictionary size will increase due to the following reason.

For example, to recognize all domestic addresses in a certain country, all place names in that country must be registered in the word dictionary for address recognition. However, for high-speed address recognition, pieces of information must be further added to the word dictionary.

For example, assume that a big city “ABC” has 1,000 or more streets. In this case, to recognize a street name in the city “ABC”, comparison with dictionary pattern sequences must be executed 1,000 or more times, even when the location of the search pattern sequence of the street name is known.

As a method of reducing the comparison count, the number of dictionary pattern sequences, which are the comparison targets, are narrowed down on the basis of a characteristic feature of the search pattern sequence, and the narrowed-down dictionary pattern sequences are compared with the search pattern sequence.

A method called bigram (N-gram; N=2) is often used when the search pattern consists of a small number of character types, e.g., alphabets. In this method, for each of 2-character strings such as “AB”, “BC”, . . . “ZZ”, a list of dictionary pattern sequences including the 2-character string is prepared in advance.

This bigram method is effective when
the number of character types is small, and
noise is readily inserted between characters.

For example, dictionary pattern sequence “JOHNSON” is registered in the lists including “JO”, “OH”, “HN”, “NS”, “SO”, and “ON.” Lists of dictionary pattern sequences, which include all 2-character possible strings in their patterns, will be hereinafter referred to as word narrow-down dictionaries.

Before comparison between the search pattern sequence and dictionary pattern sequences registered in the word dictionary is executed, 2-character strings included in the search pattern sequence are checked, and dictionary pattern sequences including them are scored. Dictionary pattern sequences having high total scores are selected and compared with the search pattern sequence, thereby recognizing the word. For example, when a street name in a city having 1,000 or more streets is to be recognized, using dictionary pattern sequences at first to 10th places of the total scores, the number of comparison procedures between the search pattern sequence and dictionary pattern sequences decreases to 1/100 or less.

However, when word narrow-down dictionaries are prepared for all city or street names in the target recognition area, the total size or capacity of word narrow-down dictionaries often becomes much larger than the total size of word dictionaries.

### BRIEF SUMMARY OF THE INVENTION

It is an object of the present invention to provide a location information recognition apparatus and method capable of recognizing location information in each country with only slight modification, and a recording medium.

In order to achieve the above abject,

according to the present invention, there is provided a location information recognition apparatus for recognizing location information written on a letter and constituted by categories which form a hierarchical structure with a plurality of stages changing in units of various countries, comprising means for selecting a dictionary and a procedure from a plurality of dictionaries corresponding to the various countries, respectively, and used to recognize the location information, and various recognition procedures which vary with the country and each of which corresponds to each category of the hierarchical structure with the plurality of stages of the location information, means for reading the location information written on the letter, and means for recognizing the read location information using the selected dictionary in accordance with the recognition procedure selected by the selection means.

According to the present invention, there is also provided a recognition method of recognizing location information constituted by categories which form a hierarchical structure with a plurality of stages varying with the country, comprising the steps of having a plurality of dictionaries corresponding to the various countries, respectively, and used to recognize the location information, having various recognition procedures which vary with the country and each of which corresponds to each category of the hierarchical structure with the plurality of stages of the location information, and in recognizing the location information, selecting one of the dictionaries, selecting one of the recognition procedures, and performing recognition processing on the basis of the selected dictionary and recognition procedure.

According to the present invention, there is also provided a recording medium used to recognize location information constituted by categories which form a hierarchical structure with a plurality of stages varying with the country, the recording medium recording a plurality of dictionaries corresponding to the various countries, respectively, and used to recognize the location information, and various recognition procedures which vary with the country and each of which corresponds to each category of the hierarchical structure with the plurality of stages of the location information.

According to the present invention, there is also provided a location information recognition apparatus comprising read means for reading a location information image, line detection means for detecting one or some character lines from the location information image read by the read means, region detection means for detecting one or some regions where location information is written from the location information image read by the read means, location information word detection means for dividing the character line detected by the line detection means and included in the location information region detected by the region detection means into one or a plurality of word regions, word recognition means for recognizing a word by collating character information included in the word region obtained by the location information word detection means with a content of a word dictionary in which place names present in an area as a recognition target are registered, and output means for outputting a recognition result by the word recognition means as a recognition result of the location information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the schematic arrangement of an address recognition apparatus according to an embodiment of the present invention;

FIG. 2 is a view showing a schematic arrangement of an address form setting section;

FIG. 3 is a view showing another schematic arrangement of the address form setting section;

FIG. 4 is a view showing a word dictionary of state names;

FIG. 5 is a view showing a word dictionary of city names;

FIG. 6 is a view showing a word dictionary of street names;

FIG. 7 is a flow chart for explaining address word recognition processing;

FIG. 8 is a view for explaining a word generated by connecting a plurality of words in address word recognition processing;

FIG. 9 is a view for explaining an example wherein a plurality of words which should be separately extracted are extracted as one word in address word recognition processing;

FIG. 10 is a flow chart for explaining address word recognition processing in which a word can be recognized even when words are erroneously concatenated;

FIG. 11 is a view for explaining division of a word;

FIG. 12 is a view showing an example of the numbers of streets in cities;

FIG. 13 is a flow chart for explaining processing of switching between execution and unexecution of word narrow-down processing depending on the number of words registered in a word dictionary; and

FIG. 14 is a flow chart for explaining processing of switching between execution and unexecution of word narrow-down processing depending on the presence/absence of a word narrow-down dictionary.

### DETAILED DESCRIPTION OF THE INVENTION

An embodiment of the present invention will be described below with reference to the accompanying drawing.

An example of a versatile address recognition apparatus (location information recognition apparatus) capable of executing address recognition (location information recognition) for each country with only slight modification will be described first.

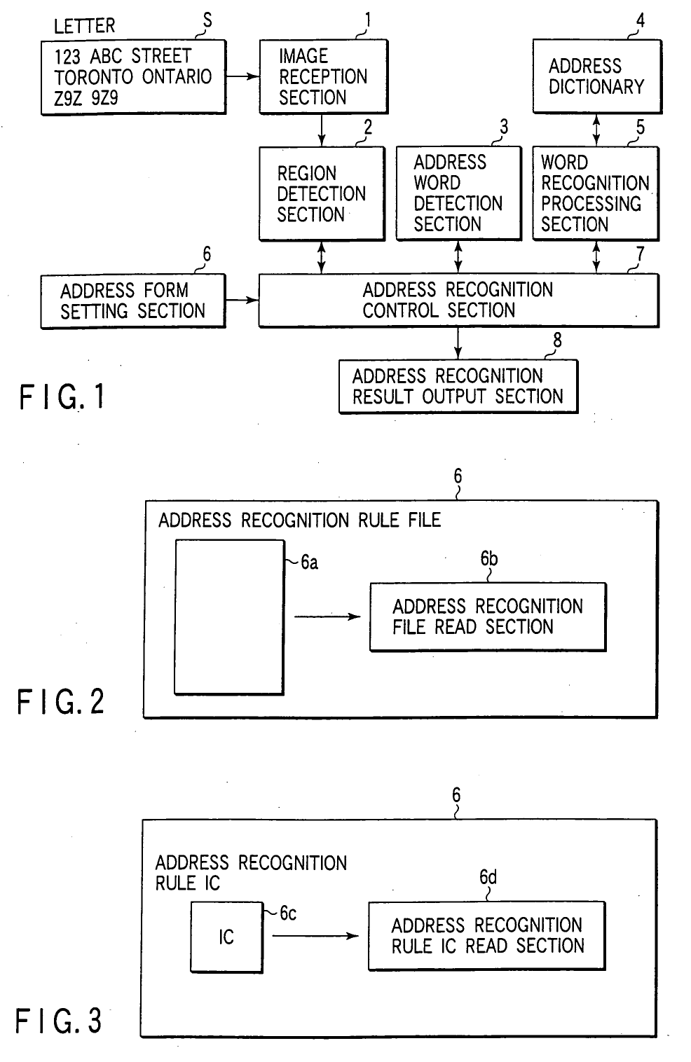

FIG. 1 is a block diagram showing the schematic arrangement of the address recognition apparatus according to the present invention.

This address recognition apparatus comprises an image reception section (read means) 1 for receiving (reading), by photoelectric conversion, an image on the upper surface of a letter S such as a mail item on which address information as location information is written, a region detection section 2 for detecting a region having an address from the image read by the image reception section 1, an address word detection section 3 for detecting one or some address words from the address region detected by the region detection section 2, a word recognition processing section 5 for recognizing a word by comparing the address word from the address word detection section 3 with an address stored in an address dictionary 4, an address form setting section 6 in which the procedure of address recognition by the word recognition processing section 5 and the address dictionary 4 to be used are set, an address recognition control section 7 for controlling the above sections, and an address recognition result output section 8 for outputting an address recognition result obtained by the address recognition control section 7.

The region detection section 2 may detect only one region or a plurality of regions for processing in descending order of possibility.

The address word detection section 3 performs processing of finding one or some address lines from the region detected by the region detection section 2 and extracting some characters or words from the lines.

The address recognition control section 7 sequentially sends a word to be recognized to the word recognition processing section 5 in accordance with the rules given by the address form setting section 6, and determines the next word to be recognized or re-reads the word while checking the recognition result returned from the word recognition processing section 5.

As the address writing method, in Japan and the like, the zip code, prefecture name, city/ward name, town name, and block name are sequentially written in this order from the uppermost line and also from the left to the right. That is, an address is written sequentially from the upper category of a hierarchical structure representing an address area.

To the contrary, in Canada and the like (Europe and America), as the address writing method, the zip code, state name, city name, street name, and street number are sequentially written in this order from the lowermost line and also from the right.

For example, as shown in FIG. 1, “123 ABC STREET TORONTO ONTARIO Z9Z 9Z9” is written.

As the recognition processing procedure set by the address form setting section 6, information related to the address form of the country or area (as a recognition target), a technique of detecting an address region, or a technique of address recognition processing is set as a set of rules. This setting can be done using hardware such as a changeover switch. Alternatively, a setting file may be prepared and read by the apparatus. The information read by the address form setting section 6 is sent to the address recognition control section 7.

As described above, when the information to be given by the address form setting section 6 is changed, addresses in different countries can be processed by a single address recognition apparatus.

An example of address recognition rule set for Japan as a recognition processing procedure set by the address form setting section 6 will be described.
Words are read from the start of a line.
Words are traced from the start to the end of a line.
The zip code is read first.
The word of prefecture name is searched subsequently after the word of zip code.
The word of city/ward name is searched subsequently after the word of prefecture name.
The word of town name is searched subsequently after the word of city/ward name.
The word next to the word of town name is recognized as block information.

An example of address recognition rule set for Canada as a recognition processing procedure set by the address form setting section 6 will be described.
Words are read from the end of a line.
Words are traced from the end to the start of a line.
The zip code is read first.
The word of state name is searched subsequently after the word of zip code.
The word of city name is searched subsequently after the word of state name.
The word of street name is searched subsequently after the word of city name.
The word next to the word of street name is recognized as a street number.

As the arrangement of the address form setting section 6, a scheme as shown in FIG. 2 is available first, in which a file which describes an address read rule set is prepared in advance and read to give the read rules to the address recognition apparatus. In this case, the address form setting section 6 is constituted by an address recognition rule file 6a and address recognition file read section 6b.

However, this scheme has the following problems.
Loading the address recognition rule file in each address recognition apparatus in shipment from the factory is cumbersome.
The security level of file information is low, and a third party can easily steal the address form setting rules.

The address dictionary 4 for each country must be often changed due to reasons such as house-moving, new construction, and district reorganization. However, once address form setting information is set, it need not often be largely corrected. Hence, as shown in FIG. 3, the address form setting rules may be printed on an IC and read out from the IC. In this case, the address form setting section 6 is constituted by an address recognition rule IC 6c and address recognition rule IC read section 6d.

At this time, the security level rises because rule analysis becomes more difficult than for a file. In addition, the address form setting information can be loaded only by inserting (attaching) the IC to the address recognition rule IC read section of the address recognition apparatus. Furthermore, the rule for address recognition in each country may be set by exchanging only the IC on which the address form setting rule is printed. In this case, the pair of address form setting rule and address dictionary can be exchanged for each country.

As the address dictionary 4, an address dictionary 4a for Japan and address dictionary 4b for Canada are prepared.

As the address dictionary 4a for Japan, a word dictionary of prefecture names, a word dictionary of city/ward names in each prefecture, and a word dictionary of town names in each city/ward are prepared.

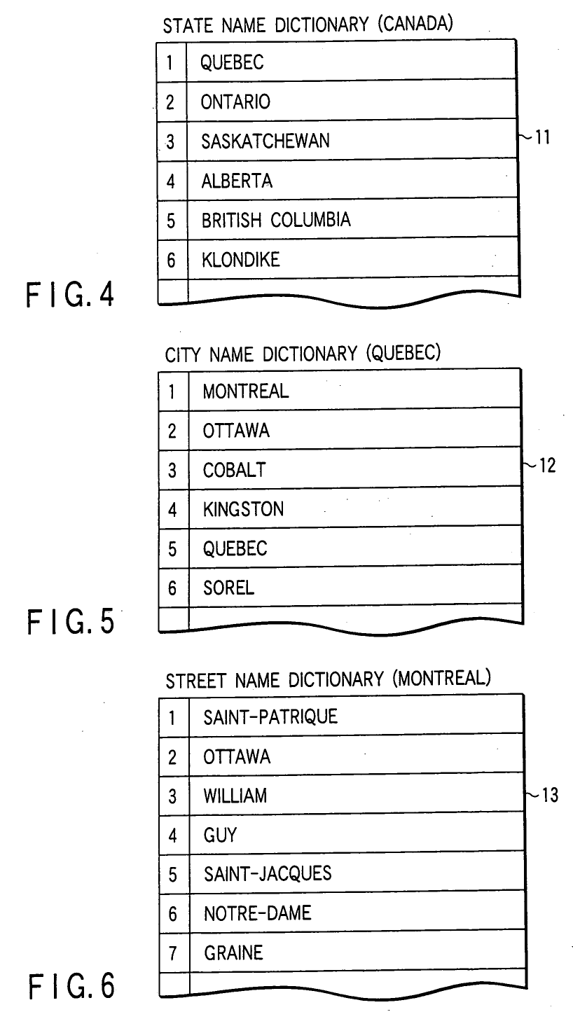

As the address dictionary 4b for Canada, a word dictionary 11 of state names, a word dictionary 12 of city names in each state, a word dictionary 13 of street names in each city, . . . are prepared, as shown in FIGS. 4 to 6.

As described above, the address form setting rule and address dictionary can be set by the address form setting section 6. That is, an address form setting rule and address dictionary corresponding to a predetermined country can be selected.

Alternatively, the image reception section 1, region detection section 2, address word detection section 3, word recognition processing section 5, address recognition control section 7, and address recognition result output section 8 may be formed from an application of recognition processing and an application of the address form setting section and address dictionary, and the application of recognition processing may execute recognition processing on the basis of the address form setting rules and address dictionary set by the address form setting section 6.

Also, the address form setting section and address dictionary may be recorded on a recording medium such as CD or DVD, a recording medium playback section may be provided in a recognition processing apparatus comprising the image reception section 1, region detection section 2, address word detection section 3, word recognition processing section 5, address recognition control section 7, and address recognition result output section 8, the address form setting rules and address dictionary may be set on the basis of contents of the address form setting section 6, which are played back by the recording medium playback section, and the recognition processing apparatus may execute recognition procession in accordance with the set contents.

Prevention of recognition errors for similar place names will be described next.

Assume that three cities “YORK”, “NORTH YORK”, and “EAST YORK” are present in a certain area. In recognizing an address in that area, even when part of the address line is recognized as “YORK”, the actual city name written there may be “NORTH YORK”.

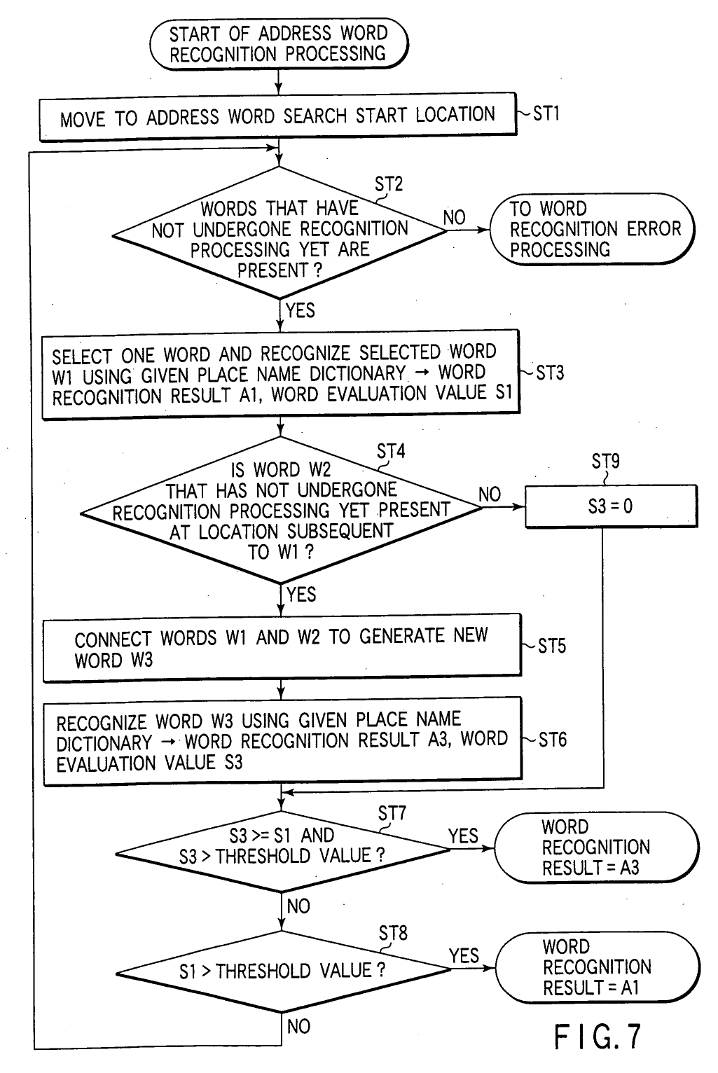

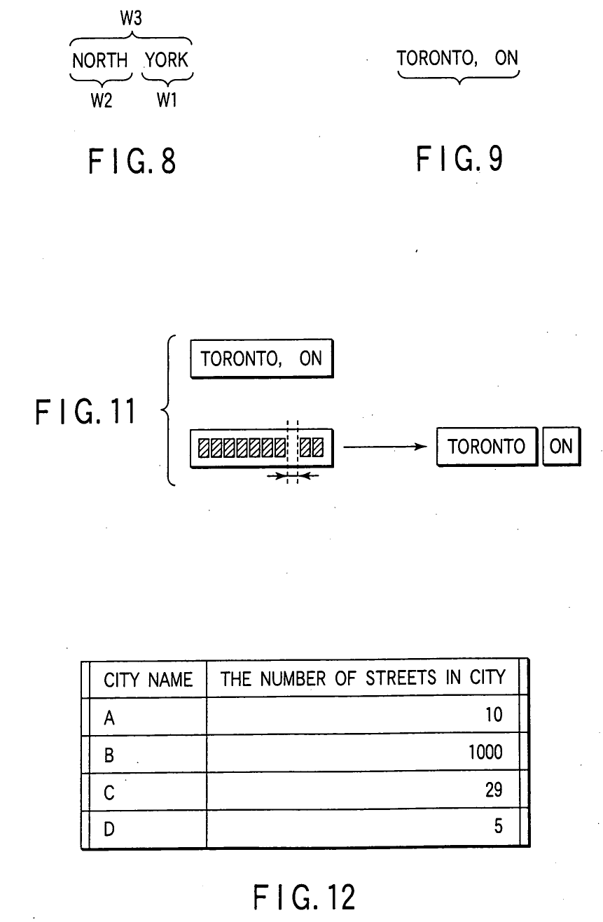

FIG. 7 is a flow chart for explaining address word recognition processing capable of discriminating between “YORK” and “NORTH YORK”. Basically, words are recognized one by one from the word recognition processing start location given by the address recognition control section 7 using the address word dictionary 4. Only with this processing, however, although “YORK” can be read, “NORTH YORK” formed from a plurality of words cannot be read. Hence, as shown in FIG. 8, a word (“YORK”) W1 currently under processing and a word (“NORTH”) W2 adjacent to the word W1 are connected to generate a new word (“NORTH YORK”) W3, and this word W3 is recognized. Although FIG. 7 exemplifies only a case wherein two words are connected, three or more words may be connected.

A result of word recognition of only one word and a result of word recognition of a word generated by connecting a plurality of words are compared, and the better result is selected. When the evaluation value of recognition result is smaller than a threshold value set in advance, neither word recognition results are selected. Instead, a word written next to the word W1 is set as a new word W1, and the above processing is repeated.

Address word recognition processing by the address recognition control section 7 will be described with reference to the flow chart shown in FIG. 7.

The address recognition control section 7 starts address word recognition processing and moves to the address word search start location (ST1). For example, when the address recognition method for Canada is set, words are sequentially read from the end of the final line.

If there are no words that have not undergone recognition processing yet (ST2), the flow advances to word recognition error processing.

When there are words that have not undergone recognition processing yet in step ST2, the address recognition control section 7 selects one word and recognizes the selected word W1 using the given place name dictionary (11, 12, or 13) (ST3). For example, when the selected word W1 corresponds to a state name, the word dictionary 11 is used. When the selected word W1 corresponds to a city name, the word dictionary 12 corresponding to the above state name is used. When the selected word W1 corresponds to a street name, the word dictionary 13 corresponding to the above city name is used.

As a result, the address recognition control section 7 calculates a word recognition result A1 and word evaluation value S1 (ST3).

The address recognition control section 7 determines next whether the word W2 that has not undergone recognition processing yet is present next to the word W1 (ST4).

If the word W2 is determined to be present, the address recognition control section 7 connects the words W1 and W2 to generate a new word W3 (ST5) and recognizes the generated word W3 using a corresponding place name dictionary (11, 12, or 13) (ST6).

As a result, the address recognition control section 7 calculates a word recognition result A3 and word evaluation value S3 (ST6).

The address recognition control section 7 compares the largest word evaluation value S1 for the word W1 with the largest word evaluation value S3 for the word W3. When the largest word evaluation value S3 for the word W3 is equal to or larger than the largest word evaluation value S1 for the word W1, and the largest word evaluation value S3 for the word W3 is larger than a predetermined threshold value (ST7), the address recognition control section 7 outputs the word recognition result A3 for the word W3 as a recognition result.

When the largest word evaluation value S1 for the word W1 is larger than the largest word evaluation value S3 for the word W3, and the largest word evaluation value S1 for the word W1 is larger than the predetermined threshold value (ST8), the address recognition control section 7 outputs the word recognition result A1 for the word W1 as a recognition result.

If steps ST7 and ST8 are not satisfied, the address recognition control section 7 returns to step ST2.

If it is determined in step ST4 that the word W2 is not present, the address recognition control section 7 sets the word evaluation value S3 for the word W3 to “0” (ST9) and advances to step ST7.

An example in this case will be described with reference to FIG. 8.

The word (“YORK”) W1 of city name and the word (“NORTH”) W2 adjacent to the word W1 are connected to generate the new word (“NORTH YORK”) W3 and the recognition results of the words W1 and W3 are compared. At this time, it is determined that the word evaluation value S3 of the recognition result of the word W3 is larger than the word evaluation value S1 for the word W1 and also larger than the threshold value, so “NORTH YORK” is recognized as a city name.

Prevention of a recognition error which is caused by extracting, as one word, a plurality of words which should be separately extracted will be described next.

When a plurality of words which should be separately extracted are extracted as one word, word recognition may fail. FIG. 9 is a view showing an example wherein two words “TORONTO” and “ON” which should be separately extracted are extracted as one word. In this case, since the city “TORONTOON” is not present in the Ontario State, city name recognition fails.

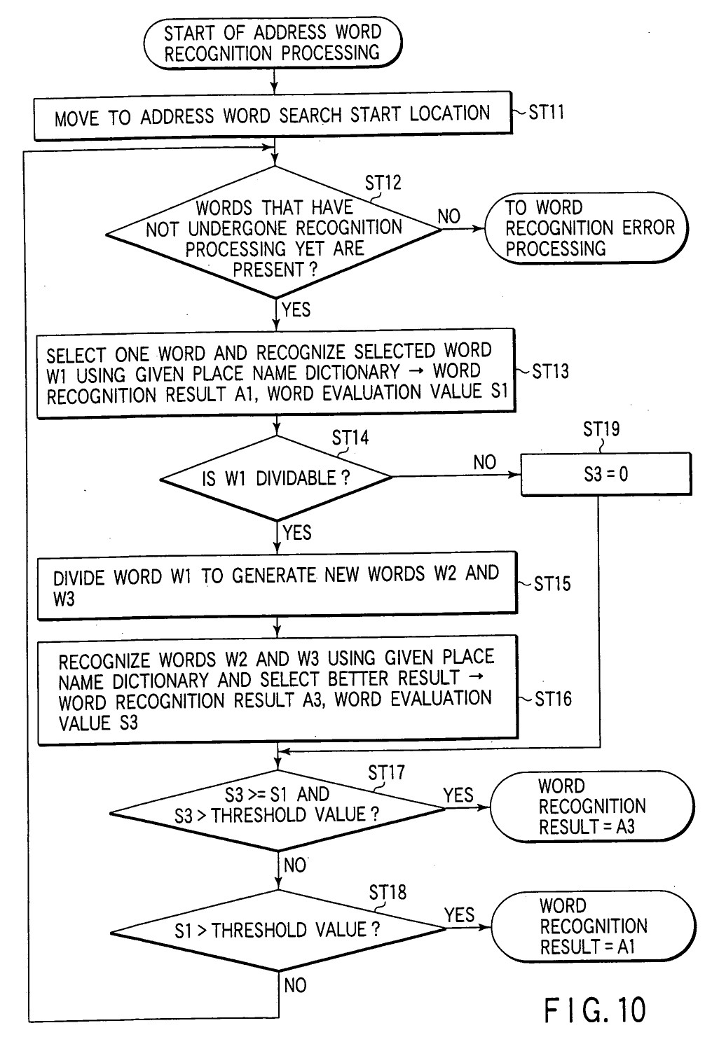

FIG. 10 is a flow chart showing address word recognition processing capable of word recognition even when such word concatenation occurs. Words are recognized one by one from the word recognition processing start location given by the address recognition control section 7, using the address word dictionary. For the word (“TORONTOON” as a city name following the Ontario State) W1, it is checked whether the word W1 satisfies a predetermined condition. If the word W1 satisfies the condition, the word W1 is divided into a plurality of words (“TORONTO”) W2 and (“ON”) W3. As the condition for word division, for example, the spacing of characters constituting a word is used. In the example shown in FIG. 11, since the character spacing is larger immediately after “TORONTO” than at remaining portions, the word is divided into two parts at that location. For example, the distance between characters is determined on the basis of word blocks obtained by vertical projection or the like. FIGS. 9 to 11 show only connection of two words for the descriptive convenience. However, one word may be divided into three or more words. Each word generated by division processing is recognized, and the best result is selected.

A result of word recognition of only one word and a result of word recognition of a word generated by dividing the word into a plurality of words are compared, and the better result is selected. When the evaluation value of recognition result is smaller than the predetermined threshold value, neither word recognition results are selected. Instead, a word written next to the word W1 is set as a new word W1, and the above processing is repeated.

Address word recognition processing by the address recognition control section 7 will be described with reference to the flow chart shown in FIG. 10.

The address recognition control section 7 starts address word recognition processing and moves to the address word search start location (ST11). For example, when the address recognition method for Canada is set, words are sequentially read from the end of the final line.

If there are no words that have not undergone recognition processing yet (ST12), the flow advances to word recognition error processing.

When there are words that have not undergone recognition processing yet in step ST12, the address recognition control section 7 selects one word and recognizes the selected word W1 using the given place name dictionary (11, 12, or 13) (ST13). For example, when the selected word W1 corresponds to a state name, the word dictionary 11 is used. When the selected word W1 corresponds to a city name, the word dictionary 12 corresponding to the above state name is used. When the selected word W1 corresponds to a street name, the word dictionary 13 corresponding to the above city name is used.

As a result, the address recognition control section 7 calculates the word recognition result A1 and word evaluation value S1 (ST13).

The address recognition control section 7 determines next whether the word W1 can be divided (ST14).

If it is determined that the word W1 can be divided into two parts, the address recognition control section 7 generates the word W2 and word W3 from the word W1 (ST15) and recognizes each of the generated words W2 and W3 using a corresponding place name dictionary (11, 12, or 13) (ST16).

As a result, the address recognition control section 7 calculates the word recognition result A3 and word evaluation value S3 (ST16).

The address recognition control section 7 compares the largest word evaluation value S1 for the word W1 with the largest word evaluation value S3 for the word W2 and W3. When the largest word evaluation value S3 for the word W2 and W3 is equal to or larger than the largest word evaluation value S1 for the word W1, and the largest word evaluation value S3 for the word W2 and W3 is larger than a predetermined threshold value (ST17), the address recognition control section 7 outputs the word recognition result A3 for the word W2 and W3 as a recognition result.

When the largest word evaluation value S1 for the word W1 is larger than the largest word evaluation value S3 for the word W2 and W3, and the largest word evaluation value S1 for the word W1 is larger than the predetermined threshold value (ST18), the address recognition control section 7 outputs the word recognition result A1 for the word W1 as a recognition result.

When steps ST17 and ST18 are not satisfied, the address recognition control section 7 returns to step ST12.

If it is determined in step ST14 that the word W1 cannot be divided, the address recognition control section 7 sets the word evaluation value S3 for the word W3 to “0” (ST19) and advances to step ST17.

An example in this case will be described with reference to FIG. 9.

For the word (“TORONTOON”) W1, and the words W2 (“TORONTO”) and (“ON”) W3 generated by dividing the word W1, the recognition results of the word W1 and words W2 and W3 are compared. At this time, it is determined that the word evaluation value S3 of the recognition result of the word W2 is larger than the word evaluation value S1 for the word W1 and also larger than the threshold value, so “TORONTO” is recognized as a city name following the Ontario State.

Down-sizing of the word narrow-down dictionary will be described next.

When an enormous number of place names are present in an area as a recognition target, the number of times of comparison between the character recognition result sequence of a word to be recognized and place name words registered in the word dictionary of place names increases, resulting in long word recognition time per word. As has already been described, this problem can be solved by decreasing the number of place name words using word narrow-down dictionaries. The word narrow-down dictionaries are provided in the address dictionary 4 or address recognition control section 7.

As the disadvantage of this scheme, when word narrow-down dictionaries are prepared for all city or street names in the target recognition area, the total size of the word narrow-down dictionaries becomes considerably large. A method of solving this problem will be described below.

For example, when dictionaries of street names in cities are generated for each city, the number of words registered in the street name dictionary greatly varies with the city. FIG. 12 shows an example of the numbers of streets in cities. The number of streets is assigned to, e.g., each dictionary of city name.

Narrowing down word candidates using word narrow-down dictionaries is effective when the number of words registered in the dictionaries is large. However, when the number of words is small, it is not only meaningless and but also time-consuming for word narrow-down processing. The word narrow-down dictionaries themselves are also unnecessary. For example, assume that high-score words at first to 20th places should be selected by word narrow-down processing. In cities A and D shown in FIG. 12, the number of streets is less than 20. Hence, the number of times of comparison between the search pattern sequence and dictionary pattern sequences is smaller than 20 without executing narrow-down processing.

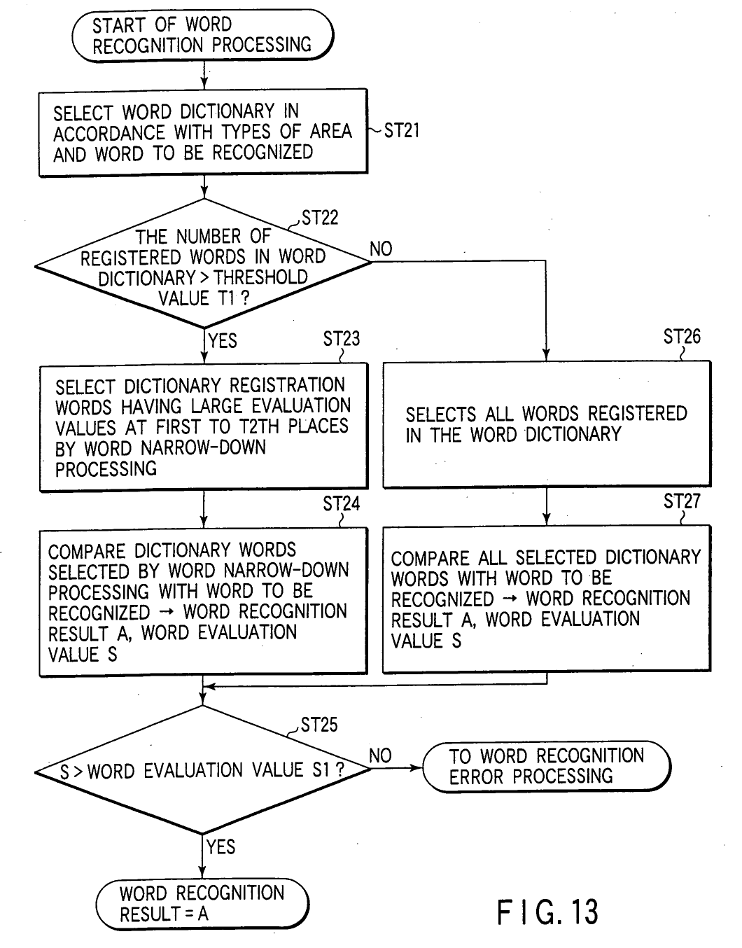

FIG. 13 is a flow chart for explaining processing of switching between execution and unexecution of word narrow-down processing depending on the number of words registered in a word dictionary.

The address recognition control section 7 starts address word recognition processing and selects the word dictionary 4 in accordance with the types of area and word to be recognized (ST21). The address recognition control section 7 determines next whether the number of words registered in the selected word dictionary 4 is larger than a threshold value T1 (20) (ST22).

When the number of registered words is determined to be larger than the threshold value T1, the address recognition control section 7 selects words having large evaluation values at first to T2th places by word narrow-down processing (ST23).

The address recognition control section 7 compares each dictionary word selected by word narrow-down processing with the word to be recognized (ST24). As a result, the address recognition control section 7 calculates a word recognition result A and word evaluation value S (ST24).

When the word evaluation value S is larger than a predetermined threshold value S1 (ST25), the address recognition control section 7 outputs the word recognition result A as a recognition result. When the word evaluation value S is equal to or smaller than the predetermined threshold value S1 (ST25), the flow advances to word recognition error processing.

If it is determined in step ST22 that the number of registered words is smaller than the threshold value T1, the address recognition control section 7 selects all words registered in the word dictionary 4 (ST26).

Next, the address recognition control section 7 compares all the selected dictionary words with the word to be recognized (ST27). As a result, the address recognition control section 7 calculates the word recognition result A and word evaluation value S (ST27). After this, the address recognition control section 7 advances to step ST25.

To reduce the total size of word narrow-down dictionaries as much as possible, narrow-down dictionaries for word dictionaries with a small number of registered words are not prepared in advance.

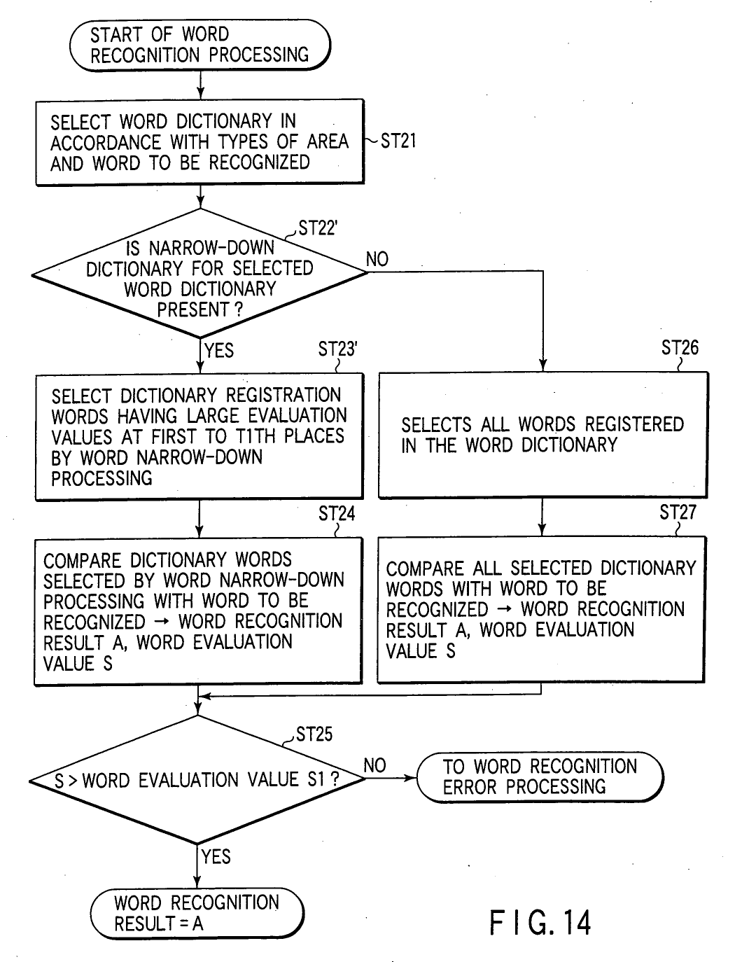

When a narrow-down dictionary is present, narrow-down processing is performed, and then word recognition processing is performed. When no narrow-down dictionary is present, word recognition processing is performed without narrow-down processing. FIG. 14 is a flow chart showing processing of switching between execution and unexecution of word narrow-down processing depending on the presence/absence of a word narrow-down dictionary. The same step numbers as in the flow chart shown in FIG. 13 denote the same steps in FIG. 14.

The address recognition control section 7 starts address word recognition processing and selects the word dictionary 4 in accordance with the types of area and word to be recognized (ST21). The address recognition control section 7 determines next whether a narrow-down dictionary for the selected word dictionary 4 is present (ST22′).

When the narrow-down dictionary is determined to be present, the address recognition control section 7 selects words having large evaluation values at first to T1th places by word narrow-down processing (ST23′).

The address recognition control section 7 compares each dictionary word selected by word narrow-down processing with the word to be recognized (ST24). As a result, the address recognition control section 7 calculates the word recognition result A and word evaluation value S (ST24).

When the word evaluation value S is larger than a predetermined threshold value S1 (ST25), the address recognition control section 7 outputs the word recognition result A as a recognition result. When the word evaluation value S is equal to or smaller than the predetermined threshold value S1 (ST25), the flow advances to word recognition error processing.

If it is determined in step ST22′ that no narrow-down dictionary is present for the selected word dictionary 4, the address recognition control section 7 selects all words registered in the word dictionary 4 (ST26).

Next, the address recognition control section 7 compares all the selected dictionary words with the word to be recognized (ST27). As a result, the address recognition control section 7 calculates the word recognition result A and word evaluation value S (ST27). After this, the address recognition control section 7 advances to step ST25.

As has been described above, even when the address form changes depending on the country, an address recognition apparatus can be constructed using a uniform hardware without customizing apparatuses for the respective countries.

With this arrangement, addresses in various countries in the world can be recognized by only a small change in settings.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A location information recognition apparatus for recognizing location information written on a letter and constituted by categories which form a hierarchical structure with a plurality of stages varying with countries, comprising:
storing means storing dictionaries of a plurality of countries and recognition procedures of a plurality of countries, each of said recognition procedures corresponding to each category of the hierarchical structure with a plurality of stages of the location information;
selecting means selecting a dictionary and a procedure respectively from said plurality of dictionaries and said plurality of recognition procedures in accordance with a country in which the apparatus is provided; and
recognizing means recognizing the location information using the selected dictionary in accordance with the recognition procedure selected by said selecting means, wherein the selecting means selects a dictionary and a procedure in advance of recognition.

2. A location information recognition method of recognizing a location information constituted by categories which form a hierarchical structure with a plurality of stages varying with countries, comprising:
storing dictionaries of a plurality of countries and recognition procedures of a plurality of countries, each of said recognition procedures corresponding to each category of the hierarchical structure with a plurality of stages of the location information;
selecting one of the dictionaries and one of the recognition procedures respectively from said plurality of dictionaries and said plurality of recognition procedures in accordance with a country in which the apparatus is provided; and
performing recognition processing on the basis of the selected dictionary and recognition procedure.

3. An apparatus according to claim 1, said recognizing means comprising:
read means reading a location information image;
line detection means detecting one or some character lines from the location information image read by said read means;
region detection means detecting one or some regions where location information is written from the location information image read by said read means;
location information word detection means dividing the character line detected by said line detection means and included in the location information region detected by said region detection means into one or a plurality of word regions;
word recognition means recognizing a word by collating character information included in the word region obtained by said location information word detection means with a content of a word dictionary in which place names present in an area as a recognition target are registered; and
output means outputting a recognition result of said word recognition means as a recognition result of the location information.

4. A location information recognition apparatus comprising:
read means reading a location information image;
line detection means detecting one or some character lines from the location information image read by said read means;
region detection means detecting one or some regions where location information is written from the location information image read by said read means;
location information word detection means dividing the character line detected by said line detection means and included in the location information region detected by said region detection means into one or a plurality of word regions;
first word recognition means recognizing the word by collating character information included in a first word region obtained by said location information word detection means with a content of a word dictionary in which the place names present in the area as the recognition target are registered and outputting a word evaluation value of the recognition result;
determination means determining whether the character information included in the first word region processed by said first word recognition means satisfies a condition for dividing the first word region into a plurality of words, wherein the condition is determined to be satisfied in a case where a distance between a certain consecutive two characters constituting a word is larger than a distance between other consecutive two characters constituting the same word;
second word recognition means recognizing the word by collating character information included in a third word region which connects the first word region processed by said first word recognition means and a second word region adjacent to the first word region in a same line with the content of the word dictionary and outputting a word evaluation value of the recognition result, and
output means comparing the word evaluation value of the recognition result by said first word recognition means with the word evaluation value of the recognition result by said second word recognition means and outputting the recognition result having a larger word evaluation value.

5. An apparatus according to claim 4, wherein said second word recognition means comprises:
determination means determining whether the character information included in the first word region processed by said first word recognition means satisfies a condition for dividing the first word region into a plurality of words; and
third word recognition means, when said determination means determines that the condition for dividing the first word region into a plurality of words is satisfied, recognizing the word by collating each of the divided words with the content of the word dictionary and outputting a word evaluation value of a recognition result.

6. An apparatus according to claim 5, wherein the condition for dividing the character information into a plurality of words, which is determined by said determination means, is satisfied when a distance between two characters nearly predetermined characters constituting the word is larger than a distance between other characters in the same word.

7. An apparatus according to claim 1, wherein said recognizing means comprises:
read means reading a location information image;
line detection means detecting one or some character lines from the location information image read by said read means;
region detection means detecting one or some regions where location information is written from the location information image read by said read means;
location information word detection means dividing the character line detected by said line detection means and included in the location information region detected by said region detection means into one or a plurality of word regions;
word recognition means recognizing a word by collating character information included in the word region obtained by said location information word detection means with a content of a word dictionary in which place names present in an area as a recognition target are registered; and
output means outputting a recognition result of said word recognition means as a recognition result of the location information;
setting means setting an order of recognition of words in each word region obtained by said location information word detection means, which corresponds to each category of the hierarchical structure with the plurality of stages constituting the location information; and
second word recognition means recognizing the word by collating the character information included in the word region obtained by said location information word detection means with a content of one of a plurality of word dictionaries in which different place names present in the area as the recognition target are registered in units of categories in accordance with the order of recognition for each word region, which is set by said setting means;
wherein said output means outputting a recognition result corresponding to each category by said second word recognition means as the recognition result of the address information.

8. An apparatus according to claim 1, wherein said recognizing means comprises:
read means reading a location information image;
line detection means detecting one or some character lines from the location information image read by said read means;
region detection means detecting one or some regions where location information is written from the location information image read by said read means;
location information word detection means dividing the character line detected by said line detection means and included in the location information region detected by said region detection means into one or a plurality of word regions;
word recognition means recognizing a word by collating character information included in the word region obtained by said location information word detection means with a content of a word dictionary in which place names present in an area as a recognition target are registered; and
output means outputting a recognition result of said word recognition means as a recognition result of the location information,
wherein the location information image read by said read means is constituted by categories which form a hierarchical structure with a plurality of stages,
said word recognition means comprises:
an integrated circuit which stores in advance an order of recognition of words in each word region obtained by said location information word detection means, which corresponds to each category of the hierarchical structure with the plurality of stages constituting the location information; and
second word recognition means recognizing the word by collating the character information included in the word region obtained by said location information word detection means with a content of one of a plurality of word dictionaries in which different place names present in the area as the recognition target are registered in units of categories in accordance with the order of recognition for each word region, which is stored in said integral circuit;
wherein said output means outputting a recognition result corresponding to each category by said second word recognition means as the recognition result of the address information.

9. An apparatus according to claim 1, wherein said recognizing means comprises:
word extraction means, corresponding to one of a plurality of word dictionaries in which different place names present in the area as the recognition target are registered in units of categories, for extracting one or a plurality of words in the word dictionary, the words matching at least some of a plurality of combinations of character strings constituted by the character information included in the word region obtained by said location information word detection means; and
second word recognition means recognizing the word by collating the character information included in the word region obtained by said location information word detection means with the one or a plurality of words extracted by said word extraction means;
wherein said output means outputting a recognition result corresponding to each category by said second word recognition means as the recognition result of the address information.

10. An apparatus according to claim 1, wherein said recognizing means comprises:
word extraction means, when the number of registered words in one of a plurality of word dictionaries in which different place names present in the area as the recognition target are registered in units of categories is not less than a predetermined number, extracting one or a plurality of words in the word dictionary, the words matching at least some of a plurality of combinations of character strings constituting the character information;
first recognition means recognizing the word by collating the character information with the one or a plurality of words extracted by said word extraction means; and
second recognition means recognizing the word by collating the character information with the content of the word dictionary when the number of registered words in the word dictionary corresponding to a predetermined category is smaller than the predetermined number;
wherein said output means outputting a recognition result by said first recognition means or a recognition result by said second recognition means as the recognition result of the address information.
